(19) United States
(12) Patent Application Publication
(10) Pub. No.: US 2015/0282476 A1
(43) Pub. Date: Oct. 8, 2015

(54) DECOY KEEL FOR AUTOMATIC MOTION

(71) Applicant: Donald Mintz, Boise, ID (US)

(72) Inventor: Donald Mintz, Boise, ID (US)

(21) Appl. No.: 14/242,873

(22) Filed: Apr. 2, 2014

(51) Int. Cl. A01M 31/06; B63H 1/30; B63B 3/38; A01M 99/00

(52) U.S. Cl. CPC A01M 31/06; A01M 99/00; B63H 1/30; B63B 3/38; B63B 2003/387

(57) ABSTRACT

A waterfowl decoy having a keel for the production of automatic motion is provided. The waterfowl decoy comprises a body, a chest or forward facing region, a tail or rearward facing region, a ventral surface or downward facing region, and a keel affixed to the ventral surface of the waterfowl decoy. When submerged in water, Bernoulli forces act on the keel translating to the ventral surface and generating automatic motion in the waterfowl decoy.

### TECHNICAL FIELD

The present embodiments relate generally to waterfowl decoys capable of automatic motion.

### BACKGROUND

Waterfowl decoys are effectively used by hunters for attracting live waterfowl to a body of water occupied by the decoys. Decoys that more accurately depict lifelike features and behaviors increase the probability of attracting waterfowl to the desired body of water.

Waterfowl decoys are man-made objects resembling a live waterfowl used by hunters to attract live waterfowl to the body of water occupied by the decoys and to the vicinity of the hunter. The success of the decoys to attract live waterfowl is attributed to the degree that the decoys accurately resemble characteristics of the living waterfowl. Visual signals produced by the decoy including appearance and behaviors matching those of live waterfowl are considered the most important criteria of a successful decoy due to the high levels visual acuity of avian species in general. Auditory signals commonly known as duck calls are also used by hunters to mimic auditory stimuli matching the sounds produced by the desired species of waterfowl. The ability of a waterfowl decoy or groups of waterfowl decoys to attract live waterfowl to a given area can be directly linked to the decoy's ability to accurately imitate combinations of signals commonly produced by live waterfowl or groups thereof so as to simulate an environment having an appearance of inhabitation by living waterfowl.

Much progress has been made over the years in the design and manufacture of waterfowl decoys to more accurately resemble the characteristics of live animals and specifically in the area of improving visual characteristics. These advancements include the use of flocking or painting techniques incorporating improved materials which accurately imitate the spectral signature created by the feathers or covering of a given species of waterfowl including the distinctive shading and light reflectance levels thereof.

The capability of a decoy to mimic the behavioral characteristics of live waterfowl is a very important factor for attracting the live animals as many distinctive waterfowl behaviors produce unique visible signals. Such behaviors include swimming, diving, directional changes, flapping wings, and other movements. These behaviors and movements are not only visible themselves, but they produce random patterns on the water surface including wakes, currents, and ripples which may be even more visible to waterfowl observing a body of water from a far than the decoy itself. Decoy behavioral matching is one of the most important factors in creating visible signals to attract live waterfowl, however efficiently and cost effective incorporation of characteristic movements and behaviors into conventional decoys has proven to be a challenge on many levels.

Conventional decoys use a rope attached to a group of decoys which can be manipulated by the hunter to produce motion. Manual intervention by the hunter to produce motion in the decoys, such as by pulling a rope attached to a group of decoys, can also draw attention to the hunter and frighten live waterfowl when the hunter's movements become visible. The requirement for manual intervention can also detract from the overall hunting experience and enjoyment levels by creating repetitive work for the hunter. Further, the motion created by the hunter when manipulating the decoys often does not resemble the true motion of living waterfowl. To reduce the need for manual intervention by the hunter and to create more lifelike motion in decoys, devices for creating automatic motion have been developed in the prior art.

U.S. Pat. No. 5,775,022 discloses a self-propelled waterfowl decoy that uses an electric motor driven tail fin for simulating the swimming characteristics of waterfowl. The motor is battery operated and moves the tail fin back and forth to create movement in the decoy. There are several disadvantages of a motorized system including additional costs and manufacturing complexity. Further, motorized systems such as these require the use of a power source, most commonly batteries, which must frequently be exchanged and adds unnecessary weight to the decoy.

### OBJECT OF THE INVENTION

An object of the invention is to provide a waterfowl decoy capable of automatic movement.

A further object of the invention is to provide a waterfowl decoy capable of no motorized automatic motion.

An additional object of the invention is to provide a waterfowl decoy which can be simply and inexpensively manufactured.

A further object of the invention is to provide a waterfowl decoy keel which lowers the center of gravity of the waterfowl decoy so as to automatically orient the decoy in an upright position.

An additional object of the invention is to provide a waterfowl decoy keel of suitable dimensions so as to enable automatic motion of the waterfowl decoy to which the keel is attached.

### SUMMARY OF THE INVENTION

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless specified otherwise, all technical and scientific terms used herein have the same meaning as commonly understood by one of ordinary skill in the art to which this disclosure belongs.

In accordance with the present invention, a waterfowl decoy is provided having a keel for the generation of movement when placed in water comprising: a body having a chest or forward facing region, a tail or rearward facing region, a ventral surface or downward facing region, a keel having a leading edge, a trailing edge and a connecting edge, said leading edge affixed to said ventral surface in a region adjacent said chest region, said trailing edge affixed to said ventral surface in a region adjacent said rearward facing region, a connecting edge joining said leading edge and said trailing edge, wherein, when the waterfowl decoy is placed in moving or turbulent water, the keel is subjected to Bernoulli forces which act on said keel to produce automatic movement in the waterfowl decoy.

The waterfowl decoy keel, as referred to herein, is defined as a structure extending downward from a surface of the waterfowl decoy, said structure being at least partially submerged in water when the waterfowl decoy is deployed.

In a preferred embodiment, the keel is a rectangular structure perpendicularly oriented relative to a ventral surface of the waterfowl decoy, said keel having a leading edge running substantially parallel to a trailing edge, said leading edge is affixed to a forward portion of the ventral surface and said trailing edge is affixed to a rearward portion of the ventral surface. Two surfaces of the keel are joined by a connecting edge, said connecting edge adjoins the leading and trailing edge and extends substantially parallel to an elongated axis of the waterfowl decoy. When the waterfowl decoy is placed in water that is moving or turbulent, the surfaces of the keel interact with Bernoulli forces to create motion in the decoy. For example, when placed into a moving body of water such as a river, Bernoulli forces in the water acting on the surfaces of the keel to create motion in the waterfowl decoy and simulate lifelike movements.

In one example, the surfaces of the keel are substantially planar.

In one example, the surfaces of the keel are curved so as to create a foil structure.

The size of the keel in a preferred embodiment and specifically, the area of the surfaces of the keel contribute to the amount of movement produced. For example, fluid force acting on a large keel surface area will create a higher overall force on the waterfowl decoy and produce a larger decoy movement compared to the movements produced by the same magnitude of fluid force acting on a keel having a smaller surface area. However, characteristics atypical of waterfowl can be produced by a keel having too great a surface area such as excessively large movements or tipping or swaying motions. Conversely, in the case that the keel surface area is too small, movements will be minimal and may not be seen by nearby waterfowl.

To produce realistic and motion, the size of the keel relative to the overall size and weight of the waterfowl decoy are important considerations. A heavier decoy will need a larger surface area of keel to produce the same magnitude of movement compared to a decoy that weighs less. In one example, a waterfowl decoy having a hollow body and a ventral surface with a length to width ratio approximating 15:8 and a keel having the dimensions of approximately 3 inches in length, 4 inches in depth and 0.5 inches wide will produce lifelike motion. When the waterfowl decoy is placed in water, the keel portion is at least partially submerged and subjected to Bernoulli forces.

The keel dimensions define a surface area on which the Bernoulli forces act and the resulting movement produced in the waterfowl decoy. The keel surface area is preferably small enough so as to translate a destabilizing interaction between the Bernoulli forces and the waterfowl decoy so as to produce a random or oscillatory motion. Conversely, a keel which is too long relative to the length of the waterfowl decoy will act to stabilize the decoy when subject to Bernoulli forces. Further, a decoy keel which does not extend to a suitable depth into the water will not appreciably translate motion generating forces to the waterfowl decoy.

Further, the location on the ventral surface of the waterfowl decoy to which the keel is affixed contributes to the directionality of decoy movement. In operation, a hunter may deploy multiple decoys at a time to simulate the behavioral characteristics of a flock of waterfowl residing in a specific body of water. To produce substantially random movements within the waterfowl decoy flock, the keel size, shape and attachment location may be varied on individual decoys to produce a random pattern of movement which will be observed as natural by passing waterfowl. In one example, placing the leading edge of the keel on the ventral surface of the waterfowl decoy from approximately 1 inch to 5 inches and preferably 3.5 inches from the front of the chest or forward facing region creates an oscillatory motion when the decoy is deployed into a moving body of water such as a river. Modifying the distance the keel is located from the chest portion can change the degree to which a decoy will oscillate, for example, when placed in a moving body of water.

The shape and symmetry of the decoy in addition to the placement symmetry of the keel on the ventral surface of the decoy will determine the symmetry of movement. In one example, a symmetrical chest region making contact with the water will produce symmetrical movements when combined with a symmetrically placed keel along the ventral surface of the decoy. Conversely, a non-symmetrical chest region combined with a symmetrically placed keel may produce non-symmetrical movements. In a preferred embodiment, a symmetrically placed keel is combined with a symmetrical chest region, such as a chest region having the shape of an arc to produce an oscillatory motion in the waterfowl decoy. In one example, an asymmetrical shape is introduced into the keel such as by modifying the length, thickness or placement of the leading edge with respect to the trailing edge of the keel so as to change the directionality of the keel. These methods of introducing asymmetrical design aid in the creation of random or uneven decoy movements and contribute to the lifelike appearance. In a preferred embodiment, the chest region is shaped so as to make contact with the water along an arced shaped region, said arc running vertically so as to limit the drag produced on the waterfowl decoy as excessive drag acts to prohibit movements generated by the keel.

In one example, a group of waterfowl decoys are provided wherein each individual decoy has a unique keel configuration relative to other decoys so as to produce a group of randomly moving decoys.

In another example, a group of waterfowl decoys are provided wherein each individual decoy has a similar or matching keel configuration relative to other decoys. However, when the decoys are placed into water, each decoy is subjected to variable forces depending on the location within the water so as to produce random movement.

An oscillatory decoy motion or random decoy motion in general and the associated patterns produced including wakes and ripples in the water is distinguished by passing waterfowl as being created by a living waterfowl whereas other inanimate objects such as rocks and branches will produce consistent, non-random patterns. The creation of random patterns within a body of water is a strong visual indicator to living waterfowl passing by that the body of water in which a waterfowl decoy or group of waterfowl decoys are deployed is occupied by other living waterfowl.

For the purposes of transport, the keel may contain a hinged region to enable folding of the keel against the ventral surface of the waterfowl decoy. Further, a means for attaching and securing the folded keel to the ventral surface of the keel is provided to facilitate packaging and transport. During transport of the waterfowl decoys, the keel would remain securely folded against the ventral surface of the decoy so as to reduce the space occupied by each decoy. Prior to deployment of the waterfowl decoy, the keel may be unfolded by means of releasing the means of attachment and rotation of the keel about the hinge into an operable orientation. In a preferred embodiment, the operable orientation of the keel may be perpendicular to the ventral surface and the keel may have a locking means so as to secure the keel in an operable orientation.

Methods of attaching a keel to the ventral surface of the waterfowl decoy are needed as they relate to the manufacturing process of both the waterfowl decoy and the keel. In a preferred embodiment the keel is formed as a continuous film with the waterfowl decoy material during manufacturing so additional keel attachment steps can be avoided so as to simplify the manufacturing process. Such manufacturing processes capable of forming a continuous keel and decoy film or layer include but are not limited to injection molding, thermoforming, blow molding, vacuum thermoforming, etc. Alternative means of attaching the keel to the waterfowl decoy include adhesives, ultrasonic welding, heat sealing, etc. Further, the keel may be attached in a removable fashion such as by means of a snap, button, in-line runner, zipper, etc., so as to enable more efficient transport and packaging of the waterfowl decoy.

In one example, the keel and waterfowl decoy are separate pieces with a means on the ventral surface of the waterfowl decoy for attachment of the keel. Thus, the decoy can be packaged or transported in a compartment of similar size and dimension to a compartment used conventionally to package or transport decoys without the added size constraint of the keel.

In one example, the means of attaching the keel to the ventral surface of the waterfowl decoy is a button.

In one example, the ventral surface of the waterfowl decoy is configured with an elongated ridge and the keel has a matching edge which slides into place along the ventral surface by means of the ridged structure.

In one example, the keel is configured with an edge having a high surface area so as to enable adhesion such as by gluing or fusion such as by ultrasonic welding or heat sealing of the keel to the ventral surface of the waterfowl decoy.

### BRIEF DESCRIPTION OF THE DRAWINGS

FIG. 1 is a side view of a waterfowl decoy in accordance with the present invention;

FIG. 2 is a front view of the waterfowl decoy;

FIG. 3 is a bottom view showing the ventral surface of a waterfowl decoy;

FIG. 4 is a perspective view of a waterfowl decoy showing an extended hinged keel attached to a ventral surface of the waterfowl decoy.

FIG. 5 is a perspective view of a waterfowl decoy showing as folded hinged keel attached to a ventral surface of the waterfowl decoy.

FIG. 6 is a perspective view of a waterfowl decoy illustrating a waterfowl decoy having a means for attaching a keel in which the keel has been removed.

FIG. 7 is a perspective view of a waterfowl decoy showing a weighted portion for lowering the center of gravity and orienting the decoy in an upright position when placed in water.

### DETAILED DESCRIPTION

In the following detailed description, reference is made to the accompanying drawings that form a part hereof and in which are shown, by way of illustration, specific embodiments. In the drawings, like numerals describe substantially similar components throughout the several views. Other embodiments may be utilized and structural or logical, changes may be made without departing from the scope of the present disclosure. The following detailed description is, therefore, not to be taken in a limiting sense.

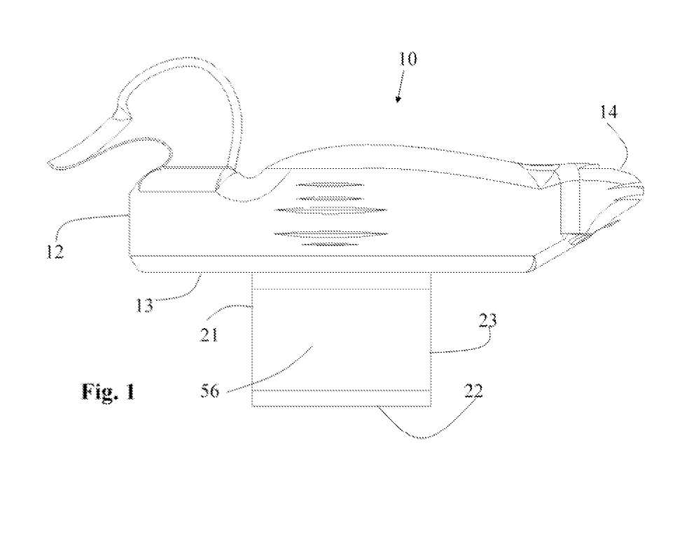

Referring to the drawings, and initially to FIG. 1, a waterfowl decoy 10 in accordance with the present invention comprises a body having a chest or forward facing region 12, a tail or rearward facing region 14, a ventral surface or downward facing region 13, a keel 56 affixed to said ventral surface or downward facing region 13, said keel having a leading edge 21, a trailing edge 23, and a connecting edge 22. In a preferred embodiment, the leading edge 21 of the keel is affixed to the ventral surface 13 of the waterfowl decoy in a region of the ventral surface adjacent the chest or forward facing region 13 and preferably at a distance from 1 to 7 inches.

Connecting edge 22 adjoins the leading edge 21 and trailing edge 23, preferably in a straight line. In a preferred embodiment, the connecting edge 22 is located at a depth from 1 to 8 inches from the ventral surface 13. Modulation of the depth of the connecting edge 22 provides a means of increasing the surface area of the keel 56 so as to control the magnitude of decoy movements produced by Bernoulli forces or turbulence within a body of water acting on the keel 56. A further means of modulating the surface area of the keel 56 by extending the distance between the leading edge 21 and the trailing edge 23 so as to increase the surface area on which Bernoulli forces act. Increasing the overall surface area of the keel 56 provides larger waterfowl decoy movements under a given force, whereas a reduction in surface area will produce relatively smaller movements. In a preferred embodiment, the ventral surface of the waterfowl decoy 10 has a length to width ratio of approximately 15:8 and provides a keel 56 having a surface area of approximately 12 square inches. In the preferred embodiment described, the connecting edge 22 has a length of approximately 3 inches and the leading edge 21 has a length of approximately 4 inches.

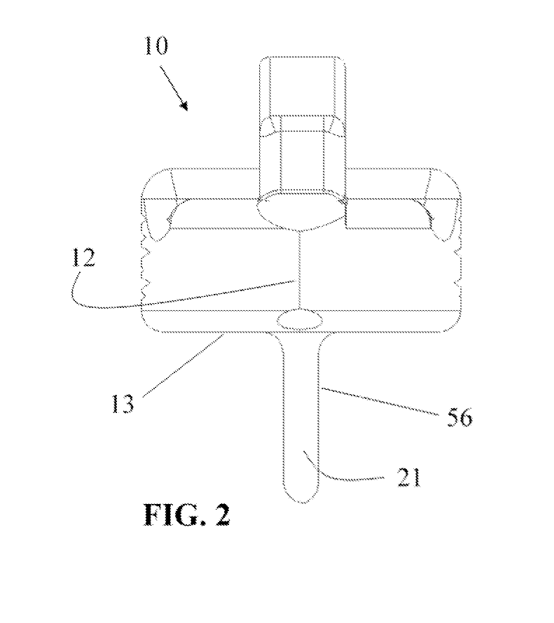

FIG. 2 is a front view of the waterfowl decoy showing a chest or forward facing region 12, a leading edge 21 of the keel 56 positioned in a preferred embodiment on a midline of the waterfowl decoy 10 to create a substantially symmetrical configuration. The symmetrical configuration by placement of the keel 56 along a midline of the waterfowl decoy allows for the generation of substantially symmetrical movements. However, it is noted that to create dissimilar movements within a group of decoys, the keel 56 placement, location, orientation, size and configuration can be substantially varied for individual waterfowl decoys without departing from the scope of the invention. Similarly, the chest or forward facing region 12 can be varied in shape to create either symmetrical or non-symmetrical movements. For example, for the production of symmetrical movements, the chest or forward facing region 12 contacting water is preferably rounded or arc shaped. The keel 56 is perpendicularly oriented to the ventral surface 13 of the waterfowl decoy 10 but can also be varied for individual waterfowl decoys to produce substantially dissimilar movements within a group of decoys. For example, the keel 56 may be affixed to the ventral surface 13 of the waterfowl decoy 10 in a non-perpendicular fashion so as to create non-symmetrical movements. A group of waterfowl decoys may have keels 56 at various angles relative to their respective ventral surfaces 13 so as to produce substantially random movements within the group of waterfowl decoys.

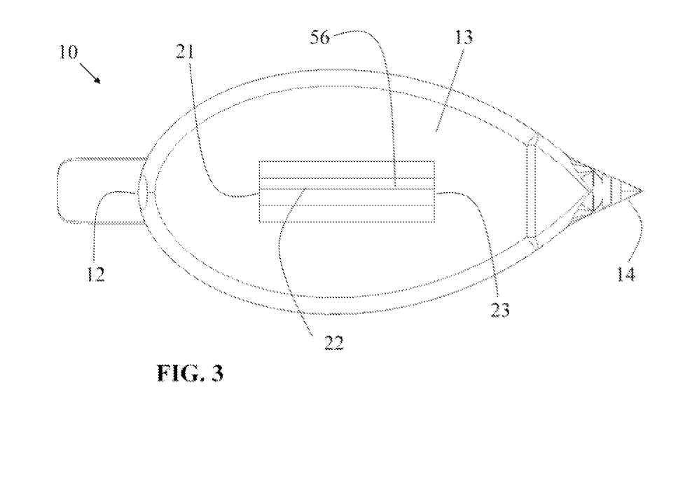

FIG. 3 is a bottom view showing the ventral surface 13 of the waterfowl decoy 10, a keel 56 is affixed to the ventral surface 13 by a leading edge 21, an a trailing edge 23, having a connecting edge 22 adjoining, the leading edge 21 and the trailing edge 23. In a preferred embodiment, the leading edge 21 is aligned with the trailing edge 23 along a midline of the waterfowl decoy.

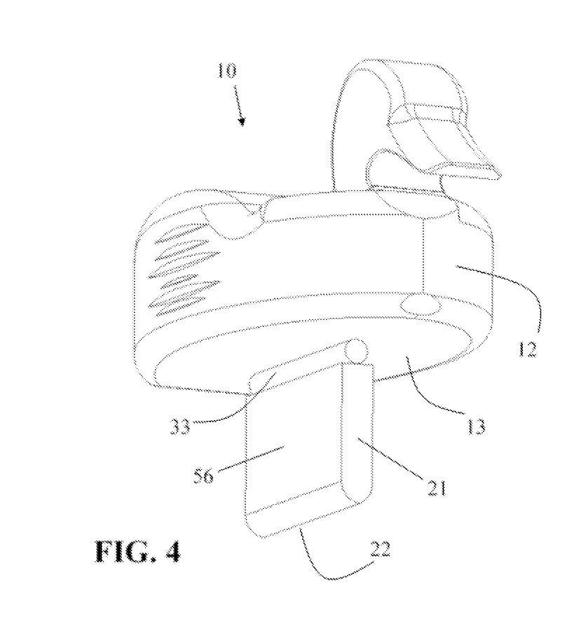

FIG. 4 shows a perspective view of a waterfowl decoy 10 having a chest or forward facing region 12 and a ventral surface or downward facing region 13 in which a keel 56 having a leading edge 21 and a connecting edge 22, said keel comprising a hinge 33 for the purpose of allowing the keel 56 to be oriented at various angles when deployed in water so as to create non-symmetrical movements if such movements are desired by the hunter. A keel oriented perpendicular to the ventral surface 13 of the decoy allows for the creation of symmetrical movements when placed in a body of water. Further, the hinge 33 enables the keel to be folded against the ventral surface 13 of the waterfowl decoy 10 for the purpose of packaging or transport of the waterfowl decoy so as to reduce the volume of the transport container or package required.

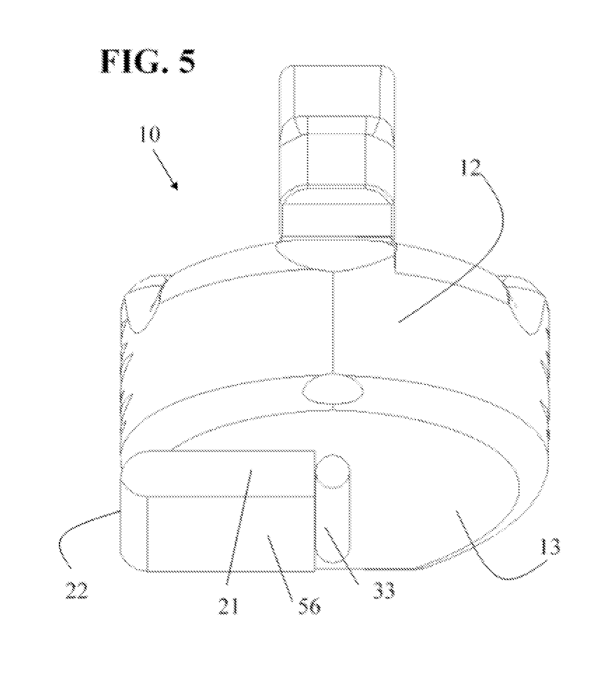

FIG. 5 is a perspective view of the ventral surface 13 of the waterfowl decoy 10 having a chest or forward facing region 12 and a keel 56 having a leading edge 21 and a connecting edge 22, said keel comprising a hinge 33 in which the keel 56 has been folded against the ventral surface 13 of the waterfowl decoy 10. A folded keel position allows for easier transport and volume reduction of associated containers or packaging. In addition, a folded keel enables the hunter to create variations in movement within a group of waterfowl decoys. For example, the keel 56 that is oriented parallel to the ventral surface 13 of the waterfowl decoy would substantially reduce Bernoulli forces created on the keel and limit or eliminate decoy movements. A keel 56 angled with respect to the ventral surface but not perpendicular would allow for the creation of asymmetrical movements.

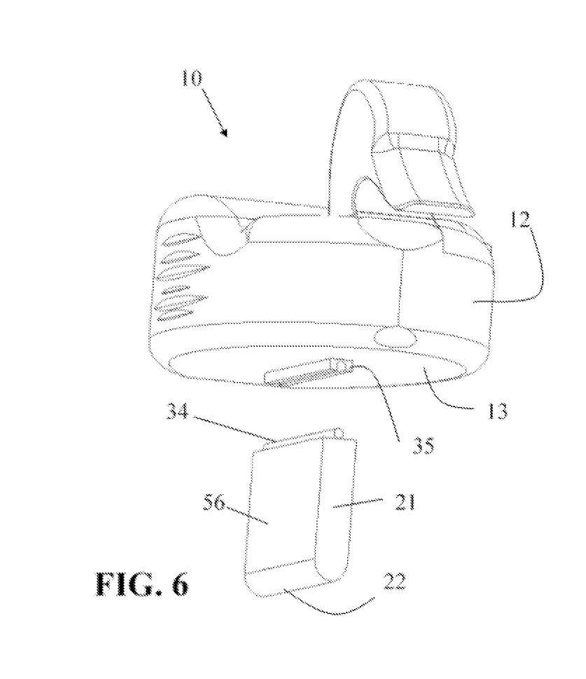

FIG. 6 is a perspective view of a waterfowl decoy 10 having a chest or forward facing region 12 a ventral surface or downward facing region 13 and a keel 56 having a leading edge 21 and a connecting edge 22. The keel 56 is shown to be disconnected from the attachment to the waterfowl decoy. The waterfowl decoy 10 comprises a means of attaching a keel 35 located on the ventral surface or downward facing region 13 of the waterfowl decoy. Similarly, the detached keel 56 comprises a complimentary structure 34 in which the keel 56 may be engaged to the waterfowl decoy using the means for attaching a keel 35. In one example, the keel 56 is removably attached to the ventral surface 13 of the waterfowl decoy using a means for attaching the keel 35. The ability to detach the keel from the waterfowl decoy allows for more efficient packaging and transport and offers the hunter an option for controlling motion within an individual decoy or group of decoys. Further, the means for attaching the keel 35 may provide additional functionality to the keel. In one example, the means for attaching a keel includes a hinge structure which enables attachment and detachment of the keel to the decoy in addition to rotation about an axis of the means for attaching the keel 35 for the purpose of folding the keel against the ventral surface of the waterfowl decoy.

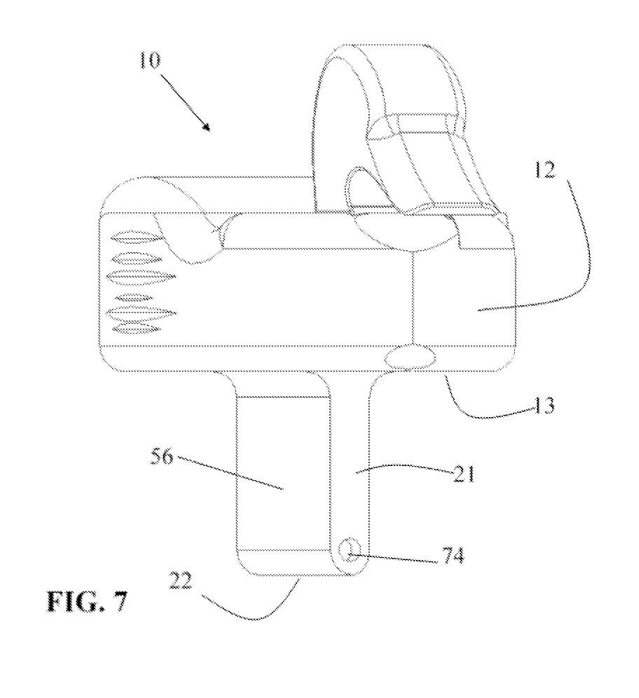

FIG. 7 is a perspective view of a waterfowl decoy 10 having a chest or forward facing region 12 a ventral surface or downward facing region 13 and a keel 56 having a leading edge 21 and a connecting edge 22. The keel 56 further comprises a weighted region 74 in which the center of gravity of the waterfowl decoy 10 is lowered so as to orient the waterfowl decoy in a upright position when placed in water. Adding a weight to the keel allows a hunter to deploy the decoy into a body of water in an upright position.

In one example, the keel is formed of a material having a weight and density suitable for lowering the center of gravity of the waterfowl decoy.

In one example, a region of the keel adjacent a connecting edge 22 is formed of a material has a weight and density suitable for lowering the center of gravity of the waterfowl decoy.

In one example, material from a region of the keel adjacent a connecting edge is removed and replaced with a material of suitable weight and density for lowering the center of gravity of the waterfowl decoy.

Although specific embodiments have been illustrated and described herein, it will be appreciated by those of ordinary skill in the art that any arrangement that is calculated to achieve the same purpose may be substituted for the specific embodiments shown. Many adaptations will be apparent to those of ordinary skill in the art. Accordingly, this application is intended to cover any adaptations or variations.

What is claimed is:

1. A waterfowl decoy which produces motion when placed in water, said waterfowl decoy comprising:
(a) a body having a chest or forward facing region, a tail or rearward facing region, a ventral surface or downward facing region;
(b) a keel, said keel having a leading edge, a trailing edge, and a connecting edge, said leading edge affixed to said ventral surface adjacent said chest or forward facing region, said trailing edge affixed to said ventral surface adjacent said tail or rearward facing region, said connecting edge joining said leading edge and said trailing edge, and;
(c) wherein, when the waterfowl decoy is placed in water, Bernoulli forces therein act on said keel to produce movement of the waterfowl decoy.

2. The waterfowl decoy of claim 1, wherein said chest or forward facing region is symmetrical along a midline axis extending from said chest or forward facing region to said tail or rearward facing region.

3. The waterfowl decoy of claim 2, wherein said chest or forward facing region is arc shaped.

4. The waterfowl decoy of claim 1, wherein said connecting edge extends downward from said ventral surface within at range of approximately 1 inch to 8 inches.

5. The waterfowl decoy of claim 1, wherein said leading edge is attached to said ventral surface within a range of approximately 1 inch to 7 inches from said chest or forward facing region.

6. The waterfowl decoy of claim 1, wherein said connecting edge is approximately 1 inch to 10 inches long.

7. The waterfowl decoy of claim 1, wherein said ventral surface or downward facing region has a width to length ratio of approximately 8:15.

8. The waterfowl decoy of claim 1, wherein said connecting edge is substantially parallel to an axis running from the chest region to the tail region and intersecting the center of gravity of the waterfowl decoy.

9. The waterfowl decoy of claim 1, wherein said waterfowl decoy further comprises a duck decoy.

10. The waterfowl decoy of claim 1, wherein said waterfowl decoy further comprises a goose decoy.

11. The waterfowl decoy of claim 1, wherein the movement of the waterfowl decoy is substantially oscillatory.

12. The waterfowl decoy of claim 1, wherein the keel comprises at least one hinge.

13. The waterfowl decoy of claim 1, wherein the keel comprises a weight suitable to orient the waterfowl decoy in an upright position when placed into a body of water.

14. A waterfowl decoy which produces motion when placed in water, said waterfowl decoy comprising:
(a) a body having a chest or forward facing region, a tail or rearward facing region, a ventral surface or downward facing region;
(b) a means of attaching a keel, and;
(c) wherein, when the keel is attached to a waterfowl decoy deployed in water, Bernoulli forces act on said keel to produce movement of the waterfowl decoy.

15. A waterfowl decoy keel for producing motion in a waterfowl decoy, said waterfowl decoy keel comprising:
(a) a leading edge, said leading edge having an upper region and a lower region;
(b) a trailing edge, said trailing edge having an upper region and a lower region;
(c) a connecting edge, said connecting edge joining the lower region of the leading edge to the lower region of the trailing edge;
(d) an attachment edge, said attachment edge connecting an upper region of the leading edge to an upper region of the trailing edge, and;
(e) wherein, when the waterfowl decoy keel is attached to a waterfowl decoy and deployed in water, Bernoulli forces act on said waterfowl decoy keel to produce movement in the waterfowl decoy.
